(19) United States
(12) Patent Application Publication
(10) Pub. No.: US 2019/0340946 A1
(43) Pub. Date: Nov. 7, 2019

(54) SYSTEM AND METHOD FOR EDUCATIONAL OFFERING STAKING AND TOKEN ARCHITECTURE

(71) Applicant: ODEM LTD., Chiasso (CH)

(72) Inventors: Adel Magdi Elmessiry, Brentwood, TN (US); Richard F. Maaghul, San Francisco, CA (US); John William Bayrd, II, Franklin, TN (US); Johanna Crotty Maaghul, San Francisco, CA (US); Michael Zargham, Oakland, CA (US)

(21) Appl. No.: 16/400,804

(22) Filed: May 1, 2019

Related U.S. Application Data
(60) Provisional application No. 62/665,418, filed on May 1, 2018.

(51) Int. Cl. G09B 5/12; H04L 9/06; G06Q 50/20; G06Q 20/06; G06Q 20/36

(52) U.S. Cl. CPC G09B 5/12; H04L 9/0637; G06Q 20/3678; G06Q 20/0658; G06Q 50/20

(57) ABSTRACT

A method may include hosting a smart contract. The smart contract may include a reference to an educational offering and one or more conditions, such as one or more student users or educator users staking tokens. The method may include receiving indication that a student user has staked the educational offering by pledging a first amount of tokens and receiving indication that an educator user has staked the educational offering by pledging a second amount of tokens. The method may include determining that the one or more conditions of the smart contract are satisfied. The method may include locking the first amount of tokens of the student user and the second amount of tokens of the educator user and issuing an educational certificate corresponding to the student user.

### CROSS-REFERENCES TO RELATED APPLICATIONS

This application claims priority to U.S. Provisional Patent Application No. 62/665,418 filed May 1, 2018 entitled SYSTEM AND METHOD FOR PROGRAM STAKING AND TOKEN ARCHITECTURE, which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The disclosure generally relates to coordinating educational offerings, and more particularly, to a system and method for educational offering staking and token architecture.

Conventional systems and methods for providing software-driven education platforms include several disadvantages. For example, an organization wishing to use an education platform usually needs to contact the platform provider directly via email or phone to request setup, customization, or modification of the platform. Such a request may involve a significant amount of time communicating back and forth between different parts of the organization and the platform provider such as a sales team, a legal team, executives, and others.

Even when the education platform is eventual provided and an educational offering is created, the organization may encounter difficulty administering the offering. The organization in charge of the offering must manually secure a teacher to teach the educational offering, a facility to host the educational offering, or students to attend the educational offering. Creating a schedule for the educational offering may be a last minute thought and may occur via manual input. Furthermore, the educational offering's curriculum may be created ad hoc by a sales team, academic coordinators, or others and may not include the input of the educational offering's instructor(s). Often, payments from students or payments to instructors, teaching assistants, or others take several days to process via wire transfer, direct deposit, or other methods, resulting in unpredictable and delayed payouts.

Additionally, degrees or other certifications from educational institutions can be difficult to verify. An organization wishing to verify a degree or transcript may need to call or email the issuing institution to determine the validity of the degree or transcript. Lastly, service providers that participate in the educational offering may be contracted on a case-by-case basis, and feedback is usually not collected, leaving quality of the educational offering unmeasured.

What is needed, then, are improvements to the education-providing arts.

### BRIEF SUMMARY

One aspect of the disclosure may include a method. The method may include a computer-implemented method. The method may include using a cryptographic distributed ledger. The ledger may include a blockchain. The ledger may be capable of wherein the cryptographic distributed ledger is capable of performing one or more steps. The steps may include hosting a smart contract. The smart contract may include a reference to an educational offering. The smart contract may include one or more conditions. The one or more conditions may include one or more student users staking tokens or one or more educator users staking tokens. The steps may include receiving indication that a student user has staked the educational offering by pledging a first amount of tokens. The steps may include receiving indication that an educator user has staked the educational offering by pledging a second amount of tokens. The steps may include receiving indication that the one or more conditions of the smart contract are satisfied. The steps may include locking the first amount of tokens of the student user and the second amount of tokens of the educator user. The steps may include, in response to receiving indication of completion of the educational offering, issuing an educational certificate corresponding to the student user on the blockchain.

Another aspect of the disclosure may include a method. The method may include a computer-implemented method. The method may include receiving an external educational activity. The method may include receiving an indication of a student user staking one or more tokens. The method may include requesting consensus from one or more established entities. The method may include receiving validation from the one or more established entities. The method may include issuing an educational certificate corresponding to the external educational activity on a blockchain. The method may include returning at least a portion of the staked tokens to the student user.

Another aspect of the disclosure may include non-transitory computer-readable storage medium. The computer-readable storage medium may include a processor and a set of instructions executable by the processor. The processor executing the set of instructions may cause the processor to implement a method. The method may include using a cryptographic distributed ledger. The ledger may be configured to define a set of prerequisite parameters, generate, based on the set of prerequisite parameters, a contract between at least two parties, store, on the decentralized ledger, the contract between the at least two parties, distribute the set of prerequisite parameters to the at least two parties, facilitate commitments between the at least two parties based on the set of prerequisite parameters, coordinate the at least two parties to carry out educational activities based on the set of prerequisite parameters, store educational activities related to the set of prerequisite parameters, verify payment for the educational activities between the at least two parties, record exchanges between the at least two parties, allow the at least two parties to stake consideration on the verification of exchanges between said at least two parties, and reward verified exchanges between said at least two parties with additional payments.

Additional objects, advantages, and novel features will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities, and combinations particularly pointed out in the appended claims.

### BRIEF DESCRIPTION OF THE DRAWINGS

FIG. 1 is a schematic block diagram illustrating an exemplary embodiment of a system for educational offering staking and token architecture.

FIG. 2A is a flowchart diagram illustrating an exemplary embodiment of a method.

FIG. 2B is a flowchart diagram illustrating an exemplary embodiment of a method.

FIG. 3 is a flowchart diagram illustrating an exemplary embodiment of a method.

FIG. 4 is a flowchart diagram illustrating an exemplary embodiment of a method.

FIG. 5 is a flowchart diagram illustrating an exemplary embodiment of a method.

FIG. 6 is a schematic block diagram illustrating an exemplary embodiment of a system.

FIG. 7 is a schematic block diagram illustrating an exemplary embodiment of a system.

FIG. 8A is a schematic diagram illustrating an exemplary embodiment of a user interface.

FIG. 8B is a schematic diagram illustrating an exemplary embodiment of a user interface.

FIG. 9 is a schematic diagram illustrating an exemplary embodiment of a user interface.

FIG. 10 is a schematic diagram illustrating an exemplary embodiment of a user interface.

FIG. 11 is a schematic diagram illustrating an exemplary embodiment of a user interface.

FIG. 12 is a schematic diagram illustrating an exemplary embodiment of a user interface.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “or” does not imply mutual exclusivity unless otherwise specified.

The present disclosure is directed to systems and methods for educational offering staking and token architecture. These systems and methods may provide an online education marketplace where users of different roles may coordinate and participate in educational offerings (e.g., classes, courses, or academic programs). The systems and methods may provide indelible, portable, or transferable proof of completion of an educational offering.

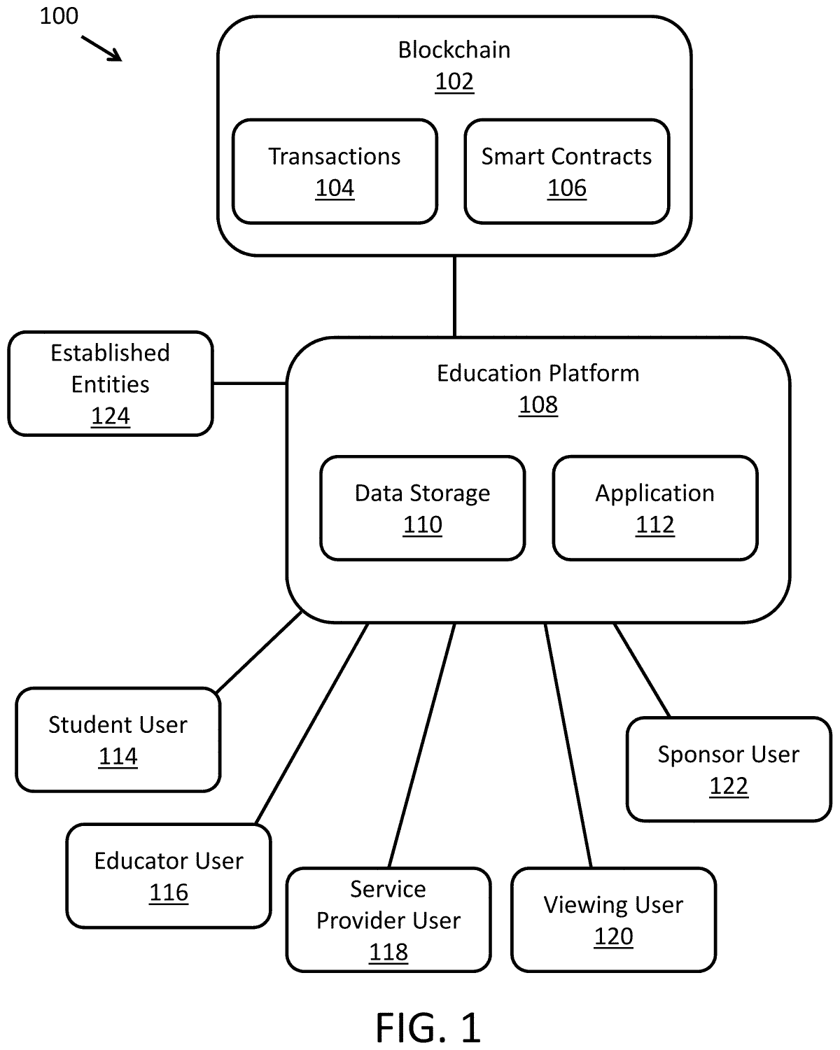

FIG. 1 depicts one embodiment of a system 100. The system 100 may include a system for educational offering staking and token architecture. The system 100 may include a blockchain 102. The blockchain 102 may include a cryptographically secured, distributed ledger that may be shared across a network of one or more computing devices called “nodes.” The one or more nodes may receive data describing transactions, assemble the received transactions into blocks, propose assembled blocks, and reach a consensus as to which blocks to add to the blockchain 102. The blockchain 102 may include one or more transactions 104. The transactions of the accepted blocks may add to the transactions 104.

The blockchain 102 may include one or more smart contracts 106. A smart contract 106 may include a self-executing contract written in computer code. The computer code may specify the terms or conditions of the smart contract 106 or behavior of the smart contract 106. In response to the terms or conditions of the smart contract 106 being satisfied, the behavior of the smart contract 106 may automatically execute. In some embodiments, the behavior of the smart contract 106 may be automatically executed by one or more nodes of the blockchain 102 and may result in the one or more nodes generating transactions 104 that represent a result of the smart contract's 106 behavior.

The system 100 may include an education platform 108. The education platform 108 may include a data storage 110. The data storage 110 may store data of the system 100. The education platform 108 may include one or more applications 112. An application 112 may include software that performs functionality in the education platform 108. The education platform 108 may be in data communication with other components of the system 100 through a data network, such as the Internet. The education platform 108 may be in data communication with the blockchain 102. The education platform 108 may send transactions to the blockchain 102 or may read data stored on the blockchain 102. The education platform 108 may be in data communication with a user device. The user device may include software that communicates with the education platform 108. The software may include a browser, a customized application, or another piece of software. A user may interact with the education platform 108 and use the functionality of the education platform 108 through the software. In some embodiments, a user device may include a student user 114, an educator user 116, a service provider user 118, a viewing user 120, a sponsor user 122, or another type of user.

The system 100 may include a type of cryptographic token, herein referred to as a token. Users of the system 100 may own tokens and utilize them to perform certain actions in the system 100 such as transferring tokens between users or staking tokens in an educational offering.

The education platform 108 may provide an educational offering that student users 114 may take and that educator users 116 may teach. A student user 114 may stake tokens to commit to taking the educational offering, and an educator user 116 may stake tokens to commit to teaching the educational offering. A smart contract 106 may detect the token-staking by the users, and, in response to staking requirements or other conditions written into the smart contract 106 being satisfied, the smart contract 106 may cause execution of one or more applications 112 in the education platform 108 to carry out the educational offering.

In response to a student user 114 completing the educational offering, the education platform 108 may issue an educational certificate for the student user 114. The educational certificate may include proof of completion of the educational offering by the student user 108. The education platform 108 may issue the educational certificate on the blockchain 102, which may result in immutable proof that the student user 114 completed the educational offering. In response to the educational offering ending, a portion of the staked tokens staked by student users 114 or educator users 116 may be returned to the staking users.

The system 100 may include one or more established entities 124. An established entity 124 may validate an external educational activity. The external educational activity may not have occurred in the education platform 108. In response to one or more established entities 124 validating the external educational activity, the education platform 108 may issue an educational certificate corresponding to the external educational activity on the blockchain 102.

The following description further describes one or more embodiments of the present disclosure. In one embodiment, a backend of the system 100 may include the blockchain 102. The blockchain 102 may be part of a blockchain platform, such as the ETHEREUM blockchain platform provided by the Ethereum Foundation. The blockchain 102 may include a blockchain hosted by a blockchain platform.

In some embodiments, the transactions 104 of the blockchain 102 may include a variety of transaction 104 types. In some embodiments, a transaction 104 may include a transfer of tokens from a first user to a second user. In some embodiments, a transaction 104 may include a user staking tokens in a specified activity, such as taking an educational offering, validating an external educational activity, or viewing an educational certificate. In one embodiment, a transaction 104 may include an educational certificate.

In some embodiments, a smart contract 106 of the blockchain 102 may include one or more parties to the smart contract 106. A party to the smart contract 106 may include a user of the system 100. A term or condition of the smart contract 106 may include a cost of an educational offering, a length of time of an educational offering, an educator that may teach an educational offering, a size of and educational offering (e.g., a class size), a location of an educational offering (e.g., a room of a physical facility, online), a material that may be required for an educational offering (e.g., a specified textbook), a service provider (e.g., a translator, caterer, transportation provider), a payment date for an educator, a condition in which a student receives a proof of completion upon completion of an educational offering, or other terms or conditions.

In one embodiment, the blockchain 102 may include credibility information for a user. Credibility information may include an educational certificate, a number of educational offerings the user has reneged, or other information that may have an impact on a user's credibility. The credibility information may be stored on the blockchain 102 in one or more transactions 104. The credibility information may assist another user in making an informed decision, such as whether to take an educational offering with another other user or not. In another embodiment, the education platform 108 may publish the smart contract 106. A published smart contract 106 may include program code that may be available to the community of users of the system 100 for reuse or modification.

In some embodiments, a computing device of the education platform 108 may be a node of the blockchain 102. In another embodiment, a computing device of the education platform 108 may be in data communication (e.g., through a data network such as the Internet) with one or more nodes of the blockchain 102. The blockchain 102 may include a permissioned blockchain, and the education platform 108 may include permission to access the blockchain 102. In some embodiments, the blockchain 102 may include an unpermissioned blockchain.

In some embodiments, a computing device of the education platform 108 may include an application server, a database server, a virtual machine, a computing cluster, or another computing device. One or more computing devices may include a distributed file system to store data. In some embodiments, a user device (e.g., a student user 114 or educator user 116) may include a desktop computer, laptop computer, tablet computer, smartphone, or other computing device.

In one embodiment, a user may include a cryptocurrency wallet. The cryptocurrency wallet may store one or more cryptocurrencies, including tokens issued by the system 100. The cryptocurrency wallet may include an address. The cryptocurrency wallet may include a public key and a private key. The user that controls the wallet may use the address and keys to conduct transactions on the blockchain 102. In one embodiment, the system 100 may include one or more mechanisms to store or recover a user's address, keys, or other wallet information. In some embodiments, one or more smart contracts 106 may include the recovery mechanisms for a user's address, key, or other wallet data. In another embodiment, the system 100 may include one or more super users. A super user may include a user controlled by the education platform 108. A super user may operate a centralized recovery mechanism for tokens or may have the ability to move tokens from one address to another to manually recover tokens for an account with a lost key, address, or other wallet data.

The education platform 108 may include a cloud platform, which may include one or more computing devices used for computing, storing data, or data communication. In one embodiment, the cloud platform may reside in a centralized location. The centralized location may be off the blockchain 102. The data storage 110 may include one or more of the computing devices used for storing data. The applications 112 may include software stored on an executed in the cloud platform. In one embodiment, the education platform 108 may include other computing architectures.

In some embodiments, an application 112 may store data in the data storage 110. The data storage 110 may include a database, file system, distributed file system, cloud storage, or another type of data storage. In some embodiments, the education platform 108 may store a portion of the data outside of the data storage 110, for example, on a third-party storage system. The stored data may include user data, educational offering data, materials associated with an educational offering (e.g., tutoring, mentoring, lecture, or other educational videos), or other data.

In one embodiment, the data storage 110 may store educational offering data. In some embodiments, the education platform 108 may store at least a portion of the educational offering data on the blockchain 102. An educational offering may include a class. A class may include a single instance of a learning activity. An educational offering may include a course. A course may include multiple classes. The classes of the course may be organized in a specific order. An educational offering may include a program. A program may include multiple courses. The courses of the program may be organized in a specific order.

For example, the education platform 108 may include an economics program. The economics program may include multiple courses, such as a Beginner Macroeconomics course, a Beginner Microeconomics course, and an Intermediate Macroeconomics course. The economics program may dictate that a user may take either Beginner course first or may take them concurrently, but that a user must complete the Beginner Macroeconomics course before taking the Intermediate Macroeconomics course. The Beginner Macroeconomics course may include multiple classes, such as Introduction to Macroeconomics, Opportunity Cost, and Supply and Demand.

In some embodiments, an educational offering may include one or more student slots. A student user 114 may stake tokens to fill a student slot. The educational offering may include one or more educator slots. An educator user 116 may stake tokens to fill the educator slot.

In one embodiment, a user of the education platform 108 may create an educational offering. The user creating the educational offering may include the user creating or selecting a class to add to a course or creating or selecting a course to add to a program. The user creating the educational offering may include the user creating or selecting educational materials for use in an educational offering such as handouts, videos, lectures, or other materials. The user creating the educational offering may include the user creating or selecting assignments that are part of an educational offering, selecting or creating tests, or creating or selecting other educational activities to be part of an educational offering.

In one embodiment, an application 112 may store one or more user profiles. A user profile may include information about a user. The information may include demographic information, login information (e.g., username, password hash), contact information, enrollment in educational offerings information, or other information. The application 112 may store user profiles in the data storage 110.

In one embodiment, a user may use an application 112 to view information provided by the education platform 108. This information may include the user's profile, educational offerings that are available for the user to enroll in, educational offerings the user is currently enrolled in, educational offerings the user has completed, events, educational certificates that the user has obtained, the user's token balance, the user's calendar, or the user's message center. In some embodiments, some information, such as the user's token balance, a user's educational certificates, or the educational offerings the user has staked tokens in may be stored on the blockchain 102 or may be derived from the transactions 104 of the blockchain 102. The education platform 108 may retrieve some of this information from the blockchain 102 for the user to view.

In some embodiments, a user may use an application 112 to request an educational offering from a catalogue of educational offerings stored on the education platform 108. For example, a student user 114 may wish to take the Beginner Macroeconomics course mentioned above. The course may be stored on the education platform 108. However, the education platform 108 may not currently be offering the course. The student user 114 may request the Beginner Macroeconomics course be offered. In response, the education platform 108 may offer the course (i.e., list the course as available for users to stake tokens in the course), keep track of how many users have requested to course and, in response to a sufficient number of users requesting the course, offer the course, or perform some other action.

In one embodiment, a user may use an application 112 to request a new educational offering. The new educational offering may include an educational offering that is not in the education platform's 108 catalogue. In some embodiments, the request for the new educational offering may include preferences that the requesting user would like to have in the new educational offering. The preferences could include one or more dates or times the educational offering would be offered, what would be taught in the educational offering, or other preference information.

In one embodiment, the education platform 108 may interact with a third-party system or application. A third-party system or application may include a computer system or software application that may not be controlled by the entity controlling the education platform 108. The third-party system or application may interact with the education system 108 to store data in the education platform 108, retrieve data from the education platform 108, sell metadata from the education platform 108 to users, enroll a user of the third-party application in an educational offering of the education platform 108 on behalf of the user of the third-party application, or cause the education platform 108 to perform some type of function.

In one embodiment, the education platform 108 may include an application 112 that allows a user to pay an extra fee to feature data more prominently on the education platform 108. The data may include data associated with the user. The education platform 108 may feature the data more prominently in an educational offering catalog, a list of educator users, searches, or other areas of the education platform 108. In one embodiment, the user may pay the extra fee in the form of a fiat currency, cryptocurrency, tokens issued by the education platform 108, or with something else of value. For example, the user may transfer tokens from the user's token wallet to a wallet controlled by the entity that controls the education platform 108.

In one embodiment, a user may use an application 112 to perform other actions in the education platform 108 such send a message to another user of the system 100, edit the user's profile, create an educational offering, create an event, or upload data.

In one embodiment, the system 100 may include one or more tokens. In some embodiments, the tokens may provide access to one or more services of the system 100 through a staking process. In one embodiment, the tokens may include, for example, Ethereum Request for Comment (ERC)-20-compliant tokens. In some embodiments, the tokens may be of a type specific to the system 100. In other words, tokens of other types cannot be used to access the services of the system 100. In some embodiments, the education platform 108 and its use may help to isolate the utility of the system 100-specific tokens from fluctuations, which may result in the use of the tokens often being advantageous. The tokens may be insulated from external cryptocurrency market forces outside the education-focused economy made up of system 100 participants. In other embodiments, the system 100 may allow users to use tokens of a token type not specific to the system 100. In some embodiments, the system's use of tokens may help eliminate issues with fiat currency. These issues may include high fees, slow processing time, or the potential of losing money due from a cyberattack or malicious activity.

A user may use an application 112 to stake an amount of tokens the user owns. In one embodiment, a user staking an amount of tokens may include the user designating the amount of tokens as committed to a certain action, such as taking an educational offering. The user may withdraw from the commitment, but the user may forfeit some of the staked tokens for reneging on the commitment. In some embodiments, in response to the user reneging on a commitment, the staking user may lose a portion of his or her staked tokens. In some embodiments, the education platform 108 may determine an amount of tokens as a penalty for reneging. The amount of tokens may be based on a timing of the reneging, the conditions of the educational offering at the time of the reneging, or other conditions. The education platform 108, in imposing a reneging penalty, may incentivize good behavior but not overly penalize. Staking the tokens or reneging may include generating a transaction 104 to post to the blockchain 102.

In some embodiments, a user staking the tokens may include the tokens becoming unavailable for the user to transfer, spend, stake in other activities, or otherwise use. For example, in some embodiments, a user staking an amount of tokens may include the user generating a transaction 104 to be included on the blockchain 102. The transaction 104 may include data indicating that the amount of tokens are unavailable for the user. In response to the user attempting to use tokens that are staked in a transaction 104, one or more nodes of the blockchain 102 may reject the attempted transaction 104 as invalid and not add the transaction 104 to the blockchain 102. In one embodiment, the user may send data to the education platform 108 instructing the education platform 108 to generate the transactions that includes the staking data.

In another example, in some embodiments, a user staking an amount of tokens may include the user generating a transaction 104 that transfers the staked amount of tokens to a cryptocurrency wallet controlled by the education platform 108. The education platform 108 may track the staked tokens of users and release the staked tokens (e.g., return at least a portion of the staked tokens to the staking user) in response to certain conditions being met, such as satisfaction of conditions in a smart contract 106. The system 100 may include other methods of locking the staked tokens or making them otherwise unavailable.

In some embodiments, a user may stake an amount of tokens in order to perform an action in the system 100. For example, a student user 114 may stake tokens in an educational offering indicating a commitment to take the educational offering. In some embodiments, the amount of tokens needed to be staked in an educational offering may be calculated according to the equation: Total Staking Amount=(percent of stake [based on Oracle/whitelist contract])×(number of seats created)×(cost to register for a seat). In some embodiments, the student user 114 may stake a percentage of the full price of the educational offering. For example, the student user 114 may stake 10% of the total cost to the student to take the educational offering, or make stake a different percentage. An educator user 116 may stake tokens in the educational offering indicating a commitment to teach the educational offering. Staking may help a user commit to an educational offering.

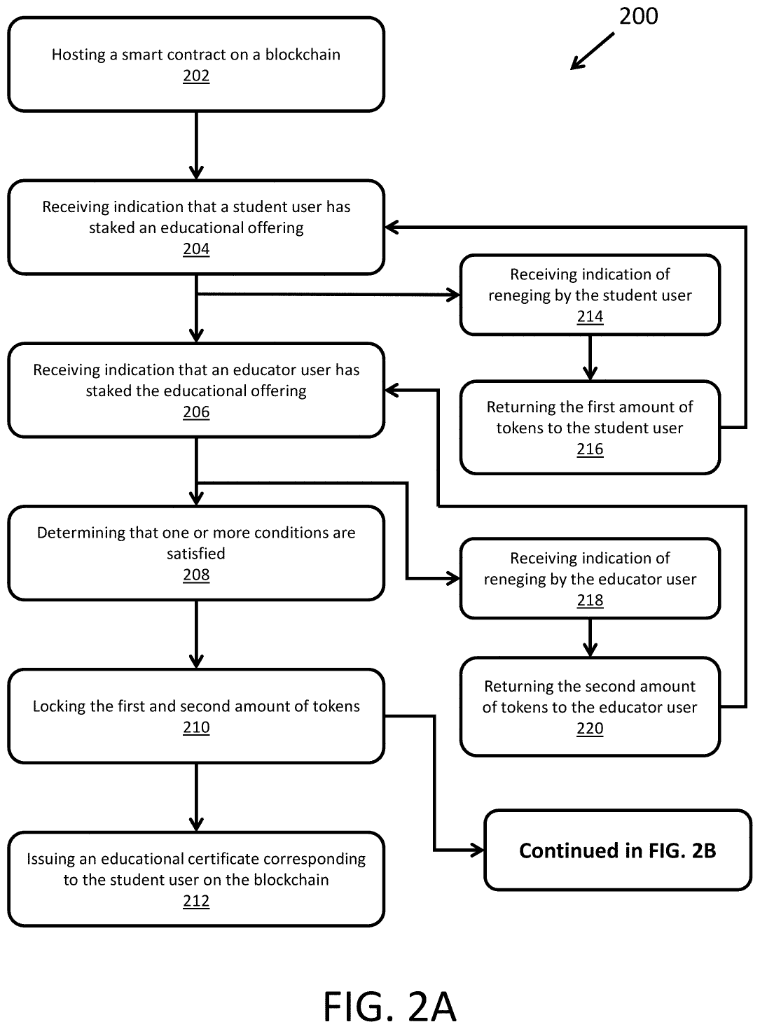

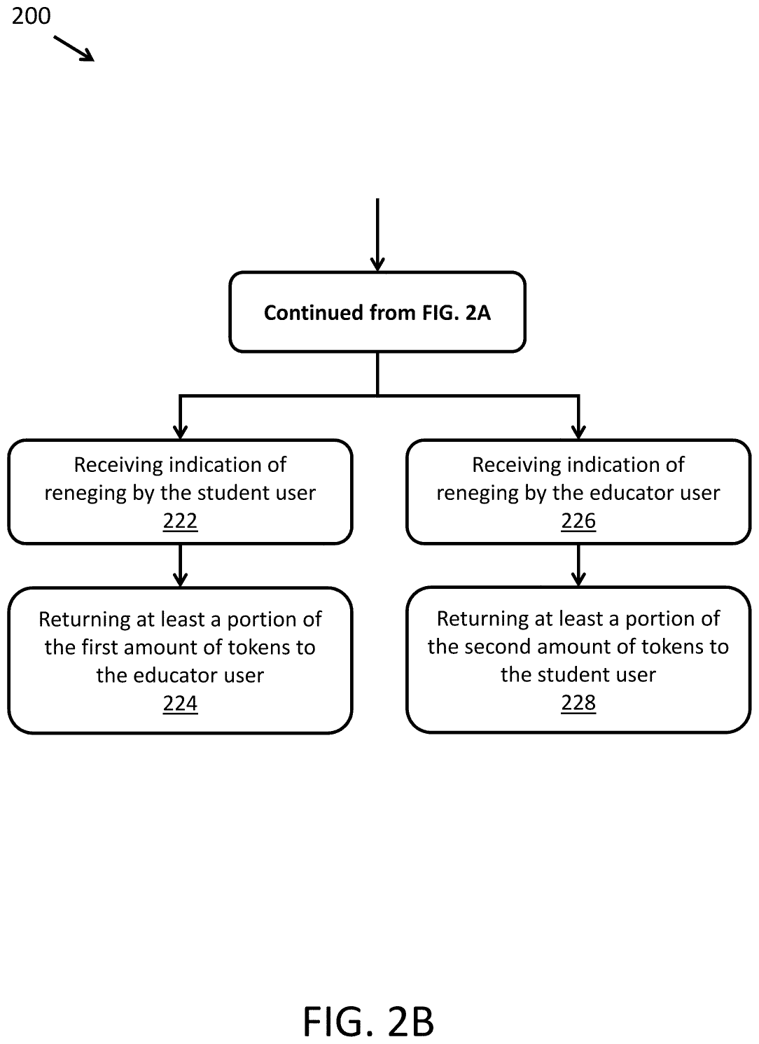

FIG. 2A and FIG. 2B depict one embodiment of a method 200. In one embodiment, the method 200 may include hosting 202 a smart contract. The smart contract may include a reference to an educational offering. The smart contract may include one or more conditions. The one or more conditions may include one or more student users staking tokens or one or more educator users staking tokens.

The method 200 may include receiving 204 indication that a student user has staked the educational offering by pledging a first amount of tokens. The method 200 may include receiving 206 indication that an educator user has staked the educational offering by pledging a second amount of tokens. The method 200 may include determining 208 that the one or more conditions of the smart contract are satisfied. The method 200 may include locking 210 the first amount of tokens of the student user and the second amount of tokens of the educator user. The method 200 may include, in response to receiving indication of completion of the educational offering, issuing 212 an educational certificate corresponding to the student user on the blockchain.

In one embodiment, the method 200 may include receiving 214 indication of reneging by the student user. In response to receiving 214 indication of reneging by the student user and the first amount of tokens of the student user not being locked 210, the method 200 may include returning 216 the first amount of tokens of the student user to the student user. In some embodiments, the method 200 may include receiving 218 indication of reneging by the educator user. In response to receiving 218 indication of reneging by the educator user and the second amount of tokens of the educator user not being locked 210, the method 200 may include returning 220 the second amount of tokens of the educator user to the educator user.

In one embodiment, after locking 210 the first amount of tokens of the student user and the second amount of tokens of the educator user, the method 200 may include receiving 222 indication of reneging by the student user. In response to receiving 222 indication of reneging by the student user, the method 200 may include returning at least a portion of the first amount of tokens of the student user to the educator user. In some embodiments, after locking 210 the first amount of tokens of the student user and the second amount of tokens of the educator user, the method 200 may include receiving 226 indication of reneging by the educator user. In response to receiving 222 indication of reneging by the educator user, the method 200 may include returning at least a portion of the second amount of tokens of the educator user to the student user.

In one embodiment, hosting 202 the smart contract on the blockchain may include generating a smart contract 106 on the blockchain 102. For example, the education platform 108 may generate one or more transactions 104 that include the code of the smart contract 106 and may post the transactions 104 to the blockchain 102. In some embodiments, receiving 204 indication that the student user has staked the educational offering may include the education platform 108 sending data to the blockchain 102 on behalf of the student user 114 indicating the staking. In another embodiment, the student user 114 may generate the transaction 104 corresponding to the staking, post the transaction 104 to the blockchain 102, and the education platform 108 may read the blockchain 102 to determine the student user 114 staked the tokens. In one embodiment, receiving 206 indication that the educator user has staked the educational offering may include similar actions to receiving 204 indication that the student user has staked the educational offering. In some embodiments, determining 208 that the first and second conditions are satisfied may include a node of the blockchain 102 network determining, from the transactions 104 of the blockchain and as part of the execution of the smart contract 106, that the conditions are satisfied.

In some embodiments, locking 210 the first amount of tokens of the student user and the second amount of tokens of the educator user may include the system 100 preventing the staking user from interacting using the locked tokens. This may include preventing the user from transferring tokens to another user, preventing the user from utilizing the tokens to stake in another activity, preventing the user from utilizing the tokens to pay for something in the system 100, or other activities. Locking the tokens of a user may include issuing a transaction 104 on the blockchain 102 designating an amount of tokens the user controls as locked. Locking the tokens of a user may include transferring the locked tokens to a cryptocurrency wallet controlled by the education platform 108. In some embodiments, locking the tokens of a user may include allowing the user to use the tokens for other purposes (e.g., withdrawing the tokens from staking), but the system 100 may impose a penalty for such reneging by the user. Locking 210 the first and second amount of tokens may include locking the educational offering. Locking the educational offering may include preventing a student user 114, educator user 116, or other type of user from staking tokens in the educational offering, joining the educational offering, or performing other actions in regard to the educational offering.

In one embodiment, issuing 212 the educational certificate corresponding to the student user on the blockchain may be in response to receiving indication of completion of the educational offering. Receiving indication of completion of the educational offering may include receiving data from the education platform 108 indicating that the end of the educational offering has arrived, or may include receiving data from the education platform 108 that one or more educational activities of the educational offering (e.g., a final exam, a final project, all activities of the educational offering) have been completed. The education platform 108 may send the completion indication in response to other occurrences associated with the educational offering. In some embodiments, the indication of the completion of the educational offerings may include one or more transactions 104 being added to the blockchain 102.

In some embodiments, issuing 212 the educational certificate may occur in response to the student user 114 earning at least a minimum grade in the educational offering, earning at least a minimum grade in one or more assignments or tests in the educational offering, or under other conditions. In some embodiments, an educational certificate may comply with one or more software protocols, such as the ERC-780 protocol. Adaptation of a protocol may provide a more general payload or may limit the method by which an educational certificate may be transferred. In some embodiments, the total number of educational certificates the system 100 may issue may grow unbounded as more users successfully complete educational offerings.

In one embodiment, an educational certificate may include one or more pieces of information. The information may include the name of the student user 114 that owns the educational certificate, the educational offering the student user 114 completed, an educator user 116 that taught the educational offering, a date of issuance, a description of the educational offering, a grade of the student user 114 associated with the educational offering (e.g., a grade on an exam, an overall grade in a course), or other information. The information may include a hash of the educational certificate or a hash of a portion of the information of the educational certificate. In one embodiment, the hash may include the hash of a distributed file system (e.g., the InterPlanetary File System developed by Protocol Labs) where a copy of the educational certificate may be accessed with a password.

In some embodiments, the educational certificate may include reference data. Reference data may include an ID, a link, or other data referencing data stored off of the blockchain 102. In some embodiments, one or more pieces of information described above may be stored off of the blockchain 102, for example, on the education platform 108 or on a third-party system. In some embodiments, by storing a portion of the information off of the blockchain 102, the system 100 may avoid higher transaction fees associated with the blockchain 102. In other embodiments, by storing more information on the blockchain 102, a user wishing to view information associated with the educational certificate may not need to access data stored off of the blockchain 102. In one embodiment, in order for a user to view a portion of the information of an educational certificate, the system 100 may require the user to spend one or more tokens to view the information. The system 100 may charge different amounts based on whether the information is stored on the blockchain 102 or off of the blockchain 102.

In some embodiments, an educational certificate may be non-fungible. An educational certificate may be non-transferable. An educational certificate may include secondary documentation of another certification. In some embodiments, an educational certificate may include characteristics such as being indelible, portable, or transferable. Some of the characteristics of an educational certificate may be a result of the educational certificate being on the blockchain 102.

In one embodiment, receiving 214 indication of reneging by the student user or receiving 218 indication of reneging by the educator user may include the student user 114 or the educator user 116 (or the education platform 108 on behalf of the student user 114 or educator user 116) generating a transaction 104 including data regarding the reneging. The student user 114, educator user 116, or education platform 108 may post the transaction 104 to the blockchain 102. The smart contract 106 may read the blockchain 102 and determine from the transactions 104 that the student user 114 or educator user 116 has reneged.

In one embodiment, receiving 222 indication of reneging by the student user or receiving 226 indication of reneging by the educator user may be similar to the steps 214 or 218. In some embodiments, returning 224 at least a portion of the first amount of tokens of the student user to the educator user may include determining a reneging penalty amount. The smart contract 106 or the education platform 108 may determine the reneging penalty amount. The reneging penalty amount may be based on the timing of the reneging. In one embodiment, the reneging penalty amount may be more (e.g., with a higher token amount taken from the user's staked tokens) if the user has reneged recently in another educational offering or has reneged multiple times in the past. The reneging penalty may be more if the user reneges later during the educational offering (e.g., the penalty may be more for reneging during the middle of a course as opposed to the first week of a course). The smart contract 106 or the education platform 108 may customize a penalty amount based on other factors.

In one embodiment, returning 228 at least a portion of the second amount of tokens of the educator user to the student user may include determining a reneging penalty amount. Determining the reneging penalty amount may be similar to the determining the reneging penalty amount discussed above in regards to the step 224. In some embodiments, returning 228 at least a portion of the second amount of tokens of the educator user to the student user may include dividing the second amount of tokens of the educator user among multiple student users 114 that have staked tokens in the educational offering.

In some embodiments, the method 200 may include a requesting, by a student user, that a pre-determined educational offering be offered. The requesting by the student user may occur before generating 202 the first smart contract or in place of generating 202 the first smart contract. In some embodiments, requesting, by the student user, that the pre-determined educational offering be offered may include the student user 114 staking tokens as part of the request. The student user 114 staking tokens may be in addition to the student user 114 staking tokens as part of step 204 or may be in place of the student user 114 staking tokens as part of step 204. Although the step 206 in FIG. 2A is depicted as occurring after step 204, in some embodiments of the method 200, receiving 206 indication that the educator user has staked the educational offering may occur before receiving 204 indication that the student user has staked the educational offering.

In some embodiments, the staking architecture of the system 100 may be based on a staking interface, such as the ERC-900 interface, and may extended a staking interface to accommodate the staking characteristics unique to the system 100. In some embodiments, the system 100 may vary fees, staking amounts, or discounts based on a user's time of adoption, reputation, or successful volume using the system 100.

In some embodiments, the staking process may apply to individual educational offerings. For example, a student user 114 may have to stake tokens in each individual class of a course that includes multiple classes. In another embodiment, the staking process may apply to an educational offering that includes multiple sub-offerings. For example, a student user 114 may only need to stake tokens in a course that includes multiple classes, and may not need to stake in each individual class. In some embodiments, each staking process may utilize a distinct smart contract 106.

In some embodiments, the smart contract 106 governing the staking for a an educational offering may include prerequisite conditions. A student user may show fulfillment of a prerequisite by having one or more required educational certificates.

In some embodiments, the method 200 may include, in response to receiving indication of completion of the educational offering, rewarding the student user for completing the educational offering, or rewarding the educator user for teaching the educational offering. Rewarding the student user or educator user may include transferring an amount of tokens to the student user 114 or the educator user 116. The amount of tokens may be in addition to the at least a portion of the first amount or second amount of tokens.

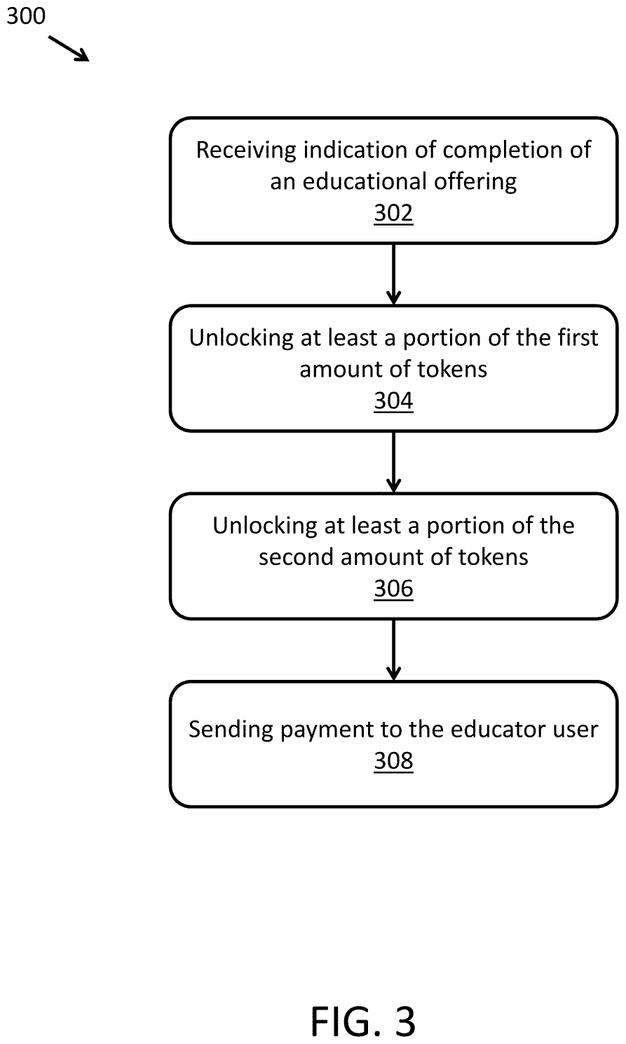

FIG. 3 depicts one embodiment of a method 300. The method 300 may include a method for ending an educational offering. The method 300 may include receiving 302 indication of completion of an educational offering. The method 300 may include unlocking 304 at least a portion of the first amount of tokens of a student user. The method 300 may include unlocking 306 at least a portion of the second amount of tokens of an educator user. The method 300 may include issuing 308 payment to the educator user. Issuing 308 payment to the educator user may include transferring a third amount of tokens to the educator user.

In one embodiment, receiving 302 indication of the completion of the educational offering may be similar to receiving indication of the completion of the educational offering as discussed above in relation to the method 200. In some embodiments, unlocking 304 at least a portion of the first amount of tokens of the student user may include returning at least a portion of the first amount of tokens staked of that student user 114 to the student user 114. The returned tokens may reward the student user 114 for fulfilling his or her commitment to take the educational offering. In one embodiment, unlocking 306 at least a portion of the second amount of tokens of the educator user may include returning at least a portion of the second amount of tokens staked of that educator user 116 to the educator user 116. The returned tokens may reward the educator user 116 for fulfilling his or her commitment to teach the educational offering. In one embodiment, the method 300 may include returning at least a portion of the first amount of tokens of the student user to the educator user. The portion of the first amount of tokens of the student user may serve as payment from the student user for the educational offering. In some embodiments, the returned tokens may be returned at another point in time, for example, on the first day of the educational offering, after an add/drop deadline, or at another point in time.

In one embodiment, sending 308 payment to the educator user may include the smart contract 106 transferring tokens to the educator user's 116 cryptocurrency wallet. The smart contract may transfer the tokens from a cryptocurrency wallet controlled by the education platform 108. In some embodiments, sending 308 payment to the educator user may include exchanging tokens for another type of currency such as fiat currency or a cryptocurrency. The fiat currency may be deposited into a bank account specified by the educator user 116 or another deposit location.

In some embodiments, sending 308 payment to the educator user may include returning a portion of the student user's 114 staked tokens to the educator user 116. Sending 308 payment to the educator user may include transferring currency to the educator user 116 via other methods (e.g., wire transfer, check, direct deposit). In one embodiment, the method 200 may include sending payment to a service provider user or another type of user. For example, the smart contract 106 may send payment to a service provider user 118 that includes a translator assisting in the educational offering. Sending payment to a service provider user or other type of user may include similar functionality as sending 308 payment to the educator user.

In some embodiments, one or more steps of the method 200 or the method 300 may be performed by a smart contract 106. In other embodiments, one or more steps of the method 200 or the method 300 may be performed by the education platform 108 or some other component of the system 100.

In some embodiments, in addition to issuing educational certificates from the education platform 108 on the blockchain 102 (e.g., as part of step 212 of the method 200), the system 100 may track external educational activities on the blockchain 102. An external educational activity may include an educational activity that did not occur as part of an educational offering of the system 100. Examples of an external educational activity may include an assignment or test from an external course, competition of an external course, a degree from an external institution (e.g., a traditional university), or other educational activities. The system 100 tracking an external educational activity may include the system 100 issuing an educational certificate corresponding to the educational activity on the blockchain 102. The educational certificate based on the external educational activity may include the same benefits as an educational certificate on the blockchain 102, i.e., being indelible, verified by multiple parties, or other benefits.

In some embodiment, a user of the system 100, such as a student user 114, may request issuance of the educational certificate that corresponds to an external educational activity. The user desiring issuance of an educational certificate corresponding to an external educational activity may stake tokens to enter the educational activity on the blockchain 102. The education platform 108 may verify with the issuing institution whether the external educational activity is valid. In response to it being valid, the education platform 108 may issue the educational certificate on the blockchain 102. The education platform 108 may notify the student user 114 in response to validation of the external educational activity. The system 100 may return the student user's 114 staked tokens. In one embodiment, an external entity, such as a university, may contract with the education platform 108 to host the external entity's proofs of educational activities on the blockchain 102. In some embodiments, the student user 114 or the external entity may pay a certificate fee to post the educational certificate on the blockchain 102. Whether the external entity is a public or private institution may determine whether the entity or the student user 114 pays the certificate fee (e.g., a private institution may pay the certificate fee, but the student user 114 may pay the certificate fee if the external educational activity occurred at a public institution). In some embodiments, an external educational activity may include a student user's 114 on-the-job accomplishment, a skill the student user 114 has obtained on-the-job, training credentials, or other credentials.

In one embodiment, an institution may not be available to verify a user's external educational activity. For example, a student user 114 may include a certificate from a traditional institution, such as a community college, indicating the student user 114 completed a certain course at the community college. The certificate may not be on the blockchain 102. However, the community college may not be able to verify the student user's 114 certificate because, for example, the community college has closed or the community college's records were lost or destroyed.

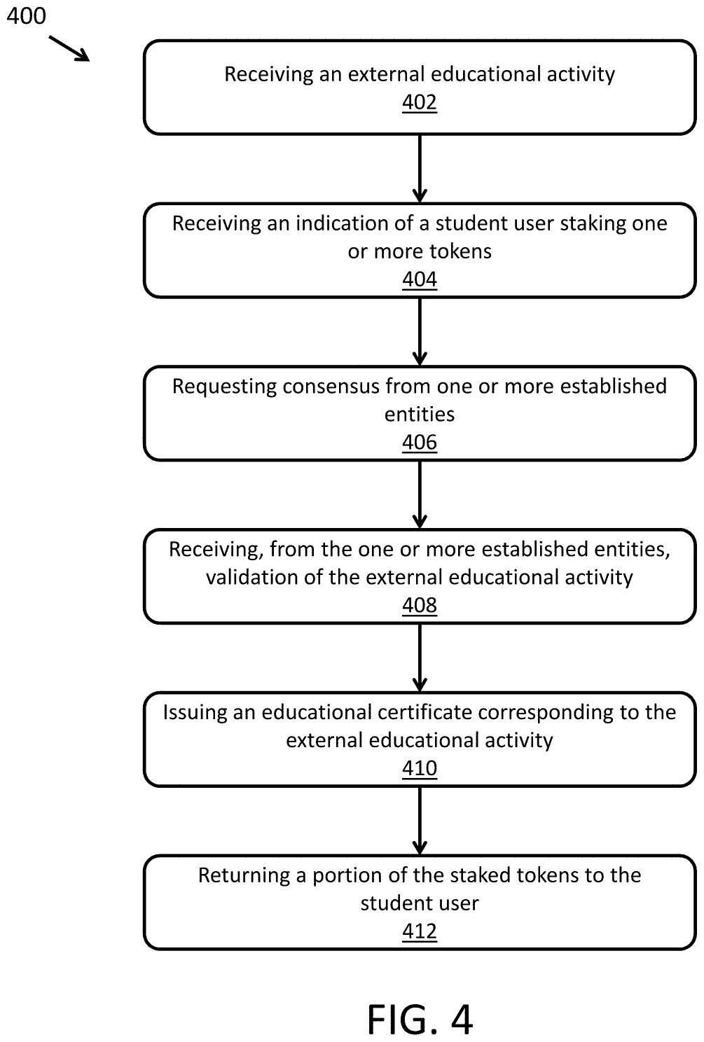

FIG. 4 depicts one embodiment of a method 400. The method 400 may include a method for verifying an external educational activity. The method 400 may include a method for verifying an external educational activity that cannot be verified by an entity such as the issuing entity. The method 400 may include receiving 402 an external educational activity. Receiving 402 the external educational activity may include a student user 114 submitting proof of the external educational activity, such as a transcript or a degree. The education platform 108 may receive the external educational activity. The method 400 may include staking 404 one or more tokens. For example, the student user 114 may stake tokens.

The method 400 may include requesting 406 consensus from one or more established entities. In one embodiment, the one or more established 124 entities may include an educational institution, an education professional, or some other entity capable of evaluating or verifying an external educational activity. An established entity 124 may examine evidence of the external educational activity and determine whether the external educational activity is valid. The method 400 may include receiving 408 validation from the one or more established entities. The method 400 may include issuing 410 an educational certificate corresponding to the external educational activity on a blockchain. For example, the education platform 108 may generate a transaction 104 that includes information about the external educational activity, and the education platform 108 may send the transaction 104 to the blockchain 102. The method 400 may include returning 412 a portion of the staked tokens to the student user.

In one embodiment, the method 400 may include notifying the student user as to the result of the verification of the transaction. In some embodiments, the education platform 108 may receive a portion of the student user's tokens as a fee for verifying and posting the proof of completion to the blockchain 102. In some embodiments, the method 400 may include one or more established entities receiving a portion of the staked tokens as a certificate fee.

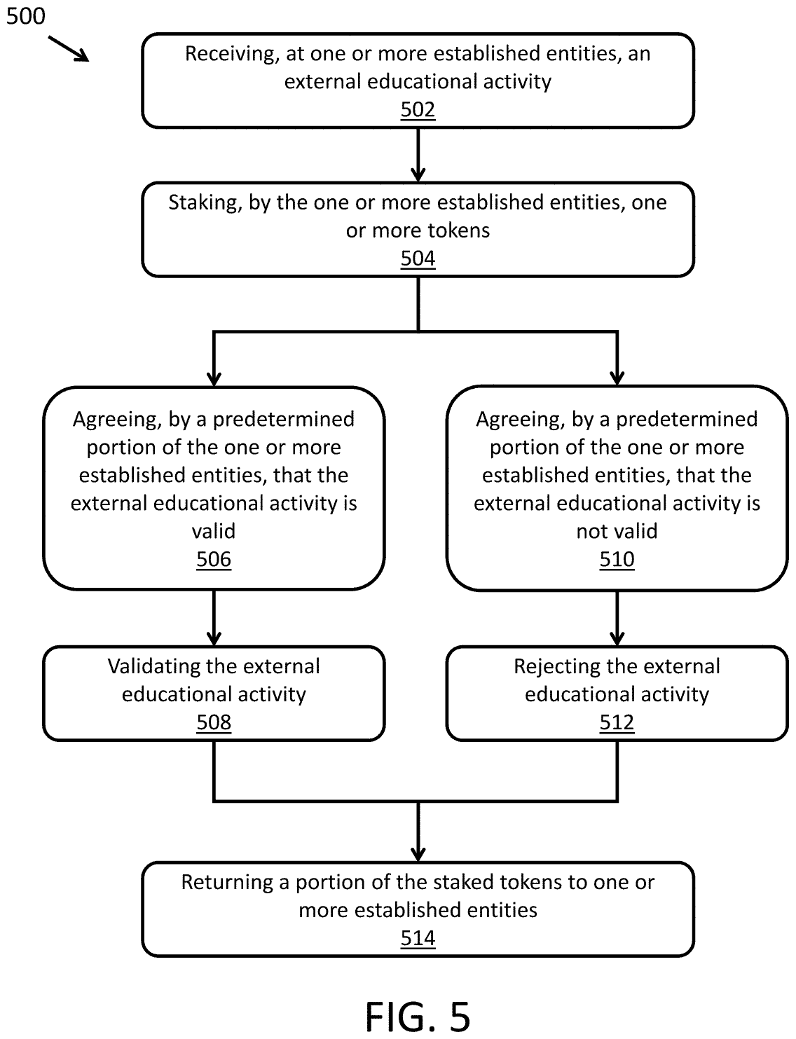

FIG. 5 depicts one embodiment of a method 500. The method 500 may include a method for reaching a consensus. The method 500 may include receiving 502, at one or more established entities, an external educational activity. The method 500 may include staking 504, by one or more established entities, one or more tokens. An established entity may include an established entity 124 of the system 100. The method 500 may include agreeing 506, by at least a predetermined portion of the established entities, that the external educational activity is valid. In response to the predetermined portion agreeing 506 that the external educational activity is valid, the method 500 may include validating 508 the external educational activity. The method 500 may include agreeing 508, by a predetermined portion of the established entities, that the external educational activity is not valid. In response to the predetermined portion agreeing 510 that the external educational activity is not valid, the method 500 may include rejecting 512 the external educational activity. The method 500 may include returning 514 a portion of the staked tokens to one or more established entities.

In one embodiment, validating 508 the external educational activity may include an established entity 124 sending indication of the validation to the education platform 108. Rejecting 512 the external educational activity may include an established entity 124 sending indication of the rejection to the education platform 108. In one embodiment the method 500 may include receiving, by one or more established entities, a portion of tokens staked by a student user 114. The received tokens may include a fee or reward for the established entities' 124 services. In some embodiments, the predetermined portion of established entities 124 may include a majority, a plurality, or some other portion. In another embodiment, the predetermined portion of established entities 124 may include a minimum number of established entities 124. In one embodiment, the minimum number may include five established entities 124. In some embodiments, returning 514 the portion of the staked tokens to one or more established entities may include returning a portion of the tokens staked by an established entity 124 that did not agree with the result to one or more established entities 124 that were part of the predetermined portion of established entities 124 that did agree with the result.

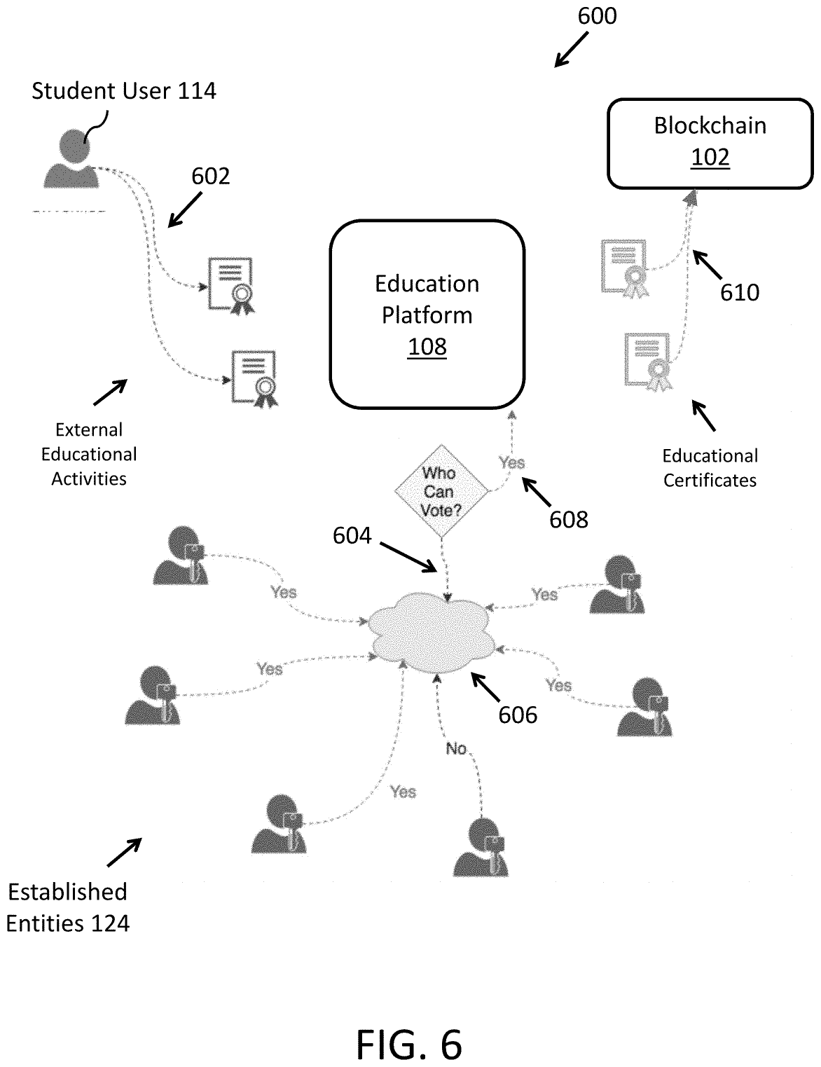

FIG. 6 depicts one embodiment of a system 600. The system 600 may include a system for verifying an external educational activity. The system 600 may include a student user 114. The student user 114 may provide 602 one or more external educational activities to the education platform 108. The student user 114 may stake an amount of tokens. The education platform 108 may send 604 the one or more external educational activities from the student user 114 to the established entities 124. The established entities may vote 606 on whether the one or more external educational activities are valid. In response to the established entities 124 reaching a consensus 608 agreeing that the one or more external educational activities are valid, the education platform 108 may issue 610 one or more educational certificate that correspond to the one or more external educational activities on the blockchain 102.

In some embodiments, the one or more applications 112 may include an educational offering selection generator application, referred to as the “offering selection application.” The offering selection application may use data from the blockchain 102, data stored on the education platform 108, or data from external sources to generate recommendations to users about educational offerings. For example, a student user 114 may input data into the education platform 108 indicating interest in an educational offering. The input data may include a search, a form filled out by the student user 114, or other input data. Input data may include the student user's 114 desired curriculum, dates, cost, educators, facilities, dining, lodging, transportation, translators, or other data. The offering selection application may, based on the input data, find a possible match to the student user's 114 request. The offering selection application may find multiple possible matches, each with a different degree of relevancy to the student user's request. The offering selection application may generate the educational offering based on the input data from the student user 114. Generating the educational offering may include generating a smart contract to facilitate fulfillment, delivery, and payment associated with the educational offering.

In some embodiments, an application 112 of the education platform 108 may include an optimization application. The optimization application may include machine learning functionality. The optimization application may identify groups users who collectively meet one or more requirements for an educational offering. The education platform 108 may notify the identified users about the educational offering. The optimization application may identify an educational offering that most closely satisfies a user's search criteria. The optimization application may generate an educational offering based on a user's search criteria, including generating a smart contract 106 for the educational offering. In one embodiment, the system 100 may send data to an external computation system to perform the functions of the optimization application. The external computation system may use optimization and machine learning capabilities or may distribute the task to be completed and verified by a network of computing devices. An example of an external computation system network may include computing systems adhering to the TrueBit protocol created by the TrueBit Foundation.

In one embodiment, the education platform 108 may send one or more surveys to a user that participates in an educational offering. The user may receive the one or more surveys after completion of the educational offering, during the educational offering, or at another time. The one or more surveys may allow the users to rate other users who participated in the educational offering, rate the educational offering or an activity or event of the educational offering, or other aspects of the educational offering. Responses to the one or more surveys may impact a user's rating or reputation stored in the system 100. In some embodiments, the system 100 may provide rewards, such as tokens, to survey participants.

In one embodiment, the system 100 may allow one or more viewing users 120 to view secure data. Secure data may include educational certificates, educational offering activity, completion rates, educator participation, or other data. In some embodiments, the viewable secure data may include data from opted-in users or may include aggregated data within the system 100. In some embodiments, opted-in users whose records were viewed may receive a portion of the tokens the viewing user 120 pays. A viewing user 120 may include an employer, university, or other entity. A viewing user 120 may include a student user 114, educator user 116, service provider user 118, or sponsor user 122. In order to view the secure data, the education platform 108 may receive, from a viewing user 120, an amount of tokens or some other currency. The education platform 108 may display an education certificate or other data to the viewing user 120. The education platform 108 may distribute a portion of the amount of tokens from the viewing user 120 to a student user 116, such as the owner of an educational certificate viewed by the viewing user 120.

In another embodiment, the education platform 108 may send data to an employer notifying the employer about one or more student users 114 that the employer may be interested in. The education platform 108 may send some of the student user's 114 information to an employer in response to the student user 114 completing a certain educational offering or earning a certain grade in an educational offering.

In some embodiments, the system 100 may allow a user to voluntarily lock a portion of his or her tokens. This voluntary locking may not be part of a staking process. In one embodiment, the user may select an amount of time for the tokens to be locked. In another embodiment, the system 100 may determine the amount of time that the user locks his or her tokens. In one embodiment, a user may receive a reward for having locked tokens. The reward amount may be based on the amount of locked tokens the user has, the length of time the user has locked to the tokens, or other considerations. The user may receive the reward periodically, such as weekly, monthly, or some other periodic interval.

In one embodiment, the system 100 may include one or more sponsor users 122. A sponsor user 122 may stake a portion of his or her tokens in an educational offering, but may not be a student user 114, an educator user 116, or another type of user participating in the educational offering. The staked tokens of the sponsor user 122 may provide tokens to an underfunded educational offering (e.g., an educational offering that does not have enough student users 114 to satisfy the educational offering's smart contract 106). A sponsor user 122 may stake a portion of his or her tokens to provide a supply of tokens to the education platform 108 to stake on his or her behalf to qualified users. In some embodiments, in response to the conclusion of an educational offering, the system 100 may return at least a portion of the staked tokens of the sponsor user 122. The system 100 may provide a predetermined amount of tokens to the sponsor user 122 as a reward for enabling the system 100. In some embodiments, the predetermined amount may include 50% of the tokens the staking provider staked or some other proportion. The predetermined amount may be an amount additional to the returned staked tokens.

In one embodiment, a sponsor user 122 may pay for another student user's 114 educational offering (e.g., stake tokens on behalf of the sponsored student user 114). A sponsor user 122 may specify the conditions of who he or she sponsors. A condition may include geography, income, age, gender, educational offering requirements (e.g., a grade earned by a sponsored student user 114), or criteria.

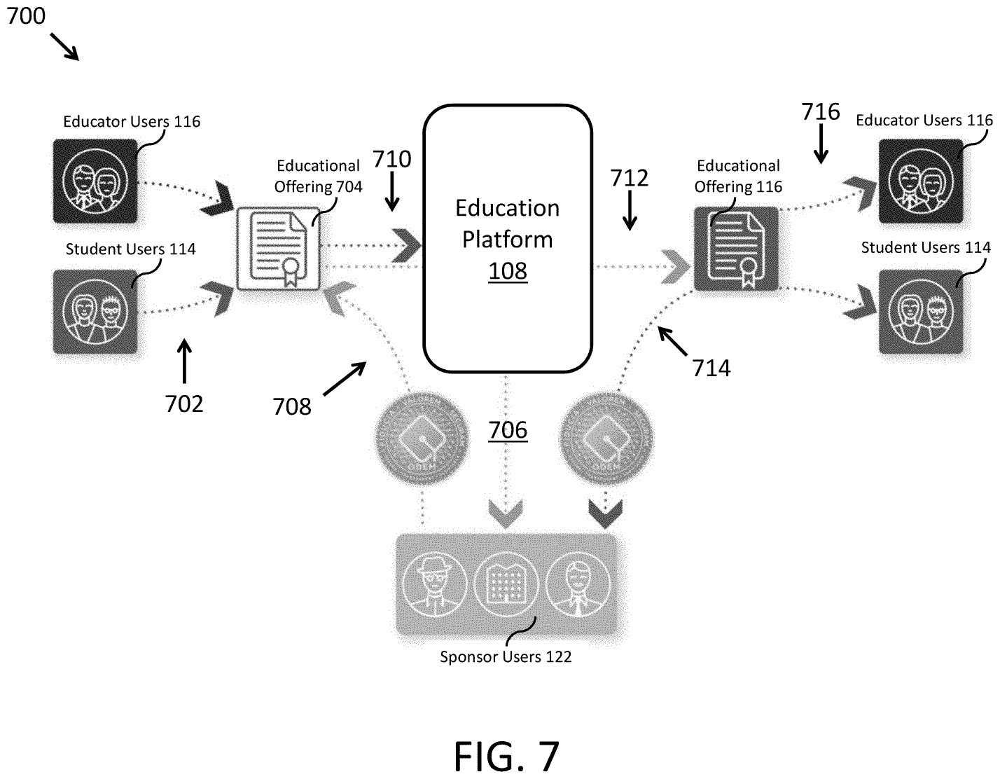

FIG. 7 depicts one embodiment of a system 700. The system 700 may include a system for sponsoring an educational offering. The system 700 may include one or more student users 114 and one or more educator users 116. The student users 114 and educator users 116 may each stake 702 tokens in an educational offering 704. The education platform 108 may request 706 that one or more sponsor users 122 sponsor the educational offering 704. The one or more sponsor users 122 may stake 708 tokens in the educational offering 704. The educational offering 704 may occur 710 with assistance from the education platform 108 (e.g., sending materials to student users 114, student users 114 submitting assignments through the education platform 108, etc.). In response to the educational offering 704 beginning or in response to the completion of the educational offering 704 (step 712), the education platform 108 may return 714 the tokens staked by the sponsor users 122 to the sponsor users 122. The education platform may also transfer 714 an amount of reward tokens to the sponsor users 122. The education platform 108 may return at least a portion of the tokens staked by the student users 114 and educator users 116.

In one embodiment, the system 100 may include functionality for value distribution or revenue sharing. The value distribution/revenue sharing functionality may include one or more smart contracts 106 that may distribute tokens to users. In some embodiments, a smart contract 106 may distribute a business commission arrangement to an education channel partner, speaking agent, literary agent, or other commissioned personnel.

In another embodiment, the education platform 108 may receive, from an educator user 116, an educator-generated educational offering. The education user 116 may generate the educational offering via interaction with the educator user's 116 computing device. The educational offering may be repeated, resold, licensed, or otherwise used in multiple instances. The education platform 108 may license the educator-generated educational offering. The education platform 108 may license the educational offering to another educator user 116. Licensing the educational offering may include allowing the other education user 116 to use or access materials from the licensed educational offering. A user that created or owns the educational offering may receive a royalty for the use of the educational offering. The royalty may include an ongoing royalty. In some embodiments, ownership of the educational offering may be tracked on the blockchain 102. The education platform 108 may generate a smart contract 106 on the blockchain 102 that may be configured to send royalty payments to the educator user 116 or another owner for use of the educator-generated educational offering.

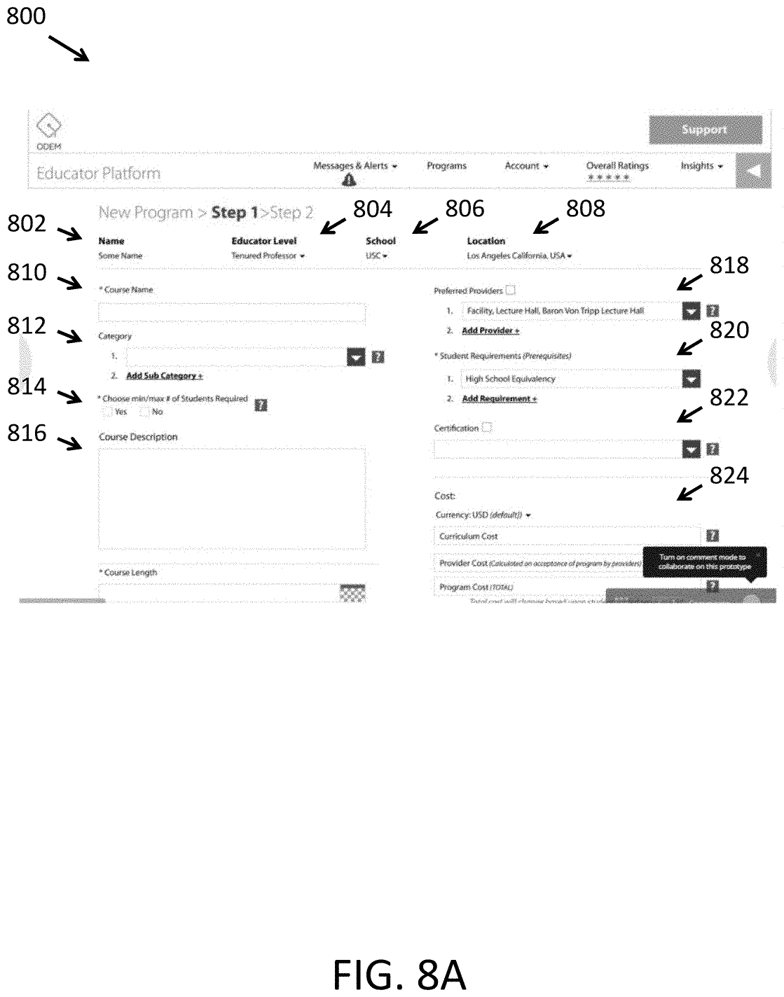

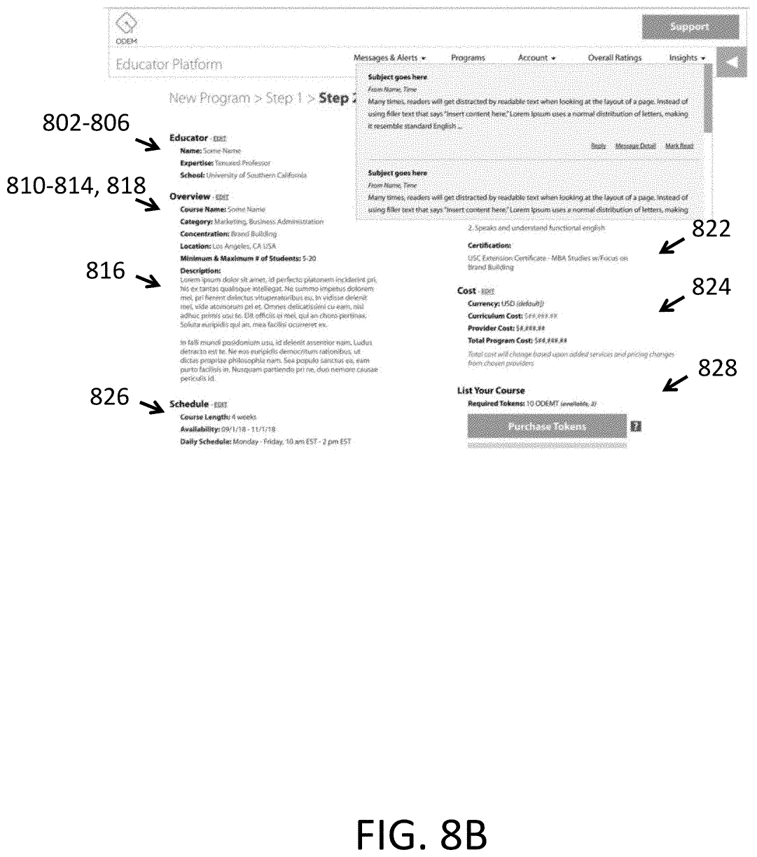

FIG. 8A depicts one embodiment of a user interface 800. The user interface 800 may include an educator user interface. The computing device of an educator user 116 may displace the user interface 800. The educator user 116 may interact with the user interface 800 to add an educational offering to the system 100. The added educational offering may include an educator-generated educational offering discussed above.

In one embodiment, the user interface 800 may include an educator name field 802. The educator user 116 may enter an educator's name in the educator name field 802. The user interface 800 may include an educator level field 804. The educator user 116 may enter a qualification that an educator of the educational offering may need in order to teach the educational offering in the educator level field 804. The user interface 800 may include a school filed 806. The educator user 116 may enter a school or other location where the educational offering is taught in the school field 806. The user interface 800 may include a location field 808. The educator user 116 may enter the location of the school where the educational offering is taught in the location field 808.

In some embodiments, the user interface 800 may include an educational offering name field 810. The educator user 116 may enter a name for the educational offering in the educational name field 810. The user interface 800 may include a category field 812. The educator user 116 may enter one or more categories for the educational offering in the category field 812. The user interface 800 may include a number of students field 814. The educator user 116 may enter a number of students for the educational offering in the number of students field 814. The number of students may include a minimum number or maximum number of students required for the educational offering. The user interface 800 may include a description field 816. The educator user 116 may enter a description for the educational offering in the description field 816.

In one embodiment, the user interface 800 may include a providers field 818. The educator user 116 may enter one or more providers in the providers field 818. A provider may include a service provider user 118 that corresponds to the provider. The user interface 800 may include a student requirements field 820. The educator user 116 may enter one or more requirements for student users 114 to have in order to enroll in the educational offering or stake tokens in the educational offering. The user interface 800 may include a certification field 822. The educator user 116 may enter an educational certificate that may issue to a student user 114 in response to the student user completing the educational offering in the certification field 822. The user interface 800 may include a cost field 824. The educator user 116 may enter one or more costs associated with the educational offering in the cost field 824. A cost may include a cost for an educator user 116, a cost for a service provider user 118, a cost for materials, or other costs. A cost may include a total cost for the educational offering.

FIG. 8B depicts another embodiment of the user interface 800. The user interface 800, as depicted in FIG. 8B, may include data entered into one or more fields described above in relation to FIG. 8A. The user interface 800, as depicted in FIG. 8B, may include similar fields as the user interface 800 depicted in FIG. 8A. For example, the user interface 800 depicted in FIG. 8B may include an educator name field 802, educator level field 804, school field 806, course name field 810, category field 812, number of students field 814, description field 816, providers field 818, certification field 822, or cost field 824.

In one embodiment, the user interface 800 may include a schedule field 826. The schedule field 826 may display a schedule for the educational offering. In one embodiment, the educator user 116 may generate the schedule via the schedule field 826. In some embodiments, the education platform 108 may generate the schedule field 826, and the educator user 116 may modify the data of the generated schedule field 826. The user interface 800 may include a tokens field 828. The educator user 116 may enter a number of tokens in the tokens field 828. The number of tokens may include the number of tokens a student user 114 is required to stake to take the educational offering, the number of tokens an educator user 116 is required to stake to teach the educational offering, the number of tokens a service provider user 118 is require to stake to provide a service for the educational offering, or the number of tokens to otherwise participate in the educational offering in some way. In some embodiments, the tokens field 828 may display a number of tokens required to create the educational offering. The tokens field 828 may include a button to purchase more tokens.

In some embodiments, a field described above may include a text field, dropdown box, radio button selection, checkbox, or other fields capable of receiving or displaying data. A field may receive data to display from the education platform 108 (e.g., options for a dropdown box, autocomplete suggestions, or other data).

In one embodiment, the educator level field 804 may include levels such as certified teacher, associate professor, tenured professor, or another level. The location field 808 may include a room, building, facility, city, state, country, or other location information. The category field 812 may include one or more categories that the educational offering may include. A category may include a skill level (beginner, intermediate, advanced, freshman, sophomore, etc.), a level of study (undergraduate, graduate, etc.), a field of study (economics, social science, English, mathematics, etc.), or some other category. In some embodiments, one or more of the data entered into the fields of the user interface 800 may be used in a smart contract 106 for the educational offering.

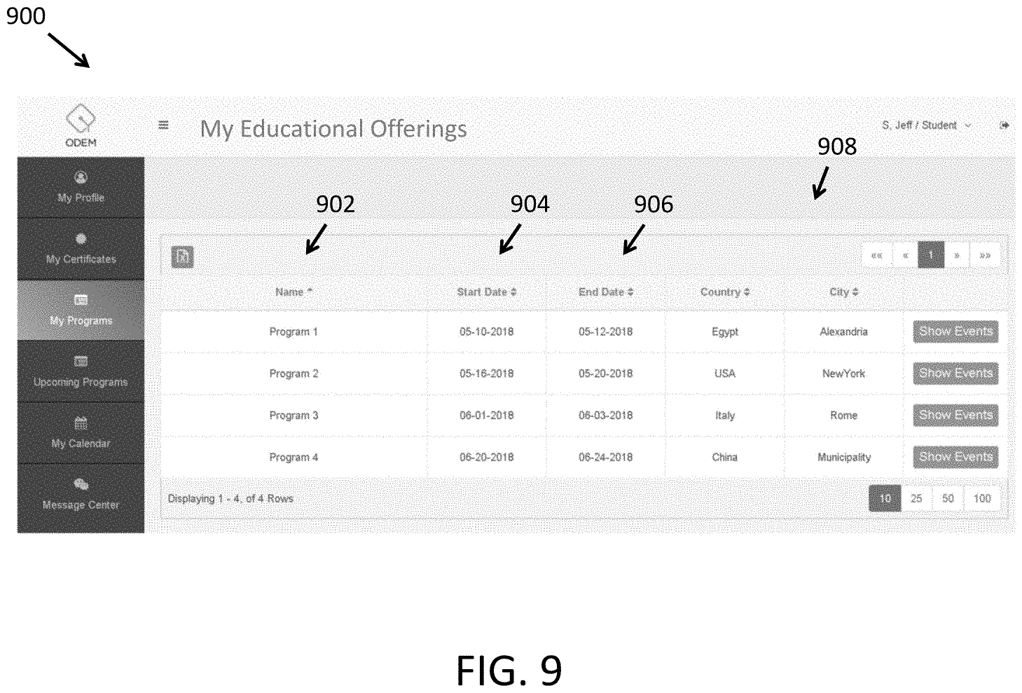

FIG. 9 depicts one embodiment of a user interface 900. The user interface 900 may include an educational offering display user interface. The user interface 900 may display information about the educational offerings. In one embodiment, the user interface 900 may include an educational offering name 902. The educational offering name 902 may include a name of a class, course, program, or other educational offering. The user interface 900 may include a start date 904 of the educational offering. The user interface 900 may include an end date 906 of the educational offering. The user interface 900 may include a location 908 of the educational offering. In some embodiments, the location 908 of the educational offering may be expressed as a room, building, facility, city, state, country, or other location information.

In some embodiments, the user interface 900 may display one or more educational offerings in which a user has staked tokens, is currently participating, has participated in, or is otherwise involved with. The user interface 900 may be displayed to a student user 114, educator user 116, or other type of user.

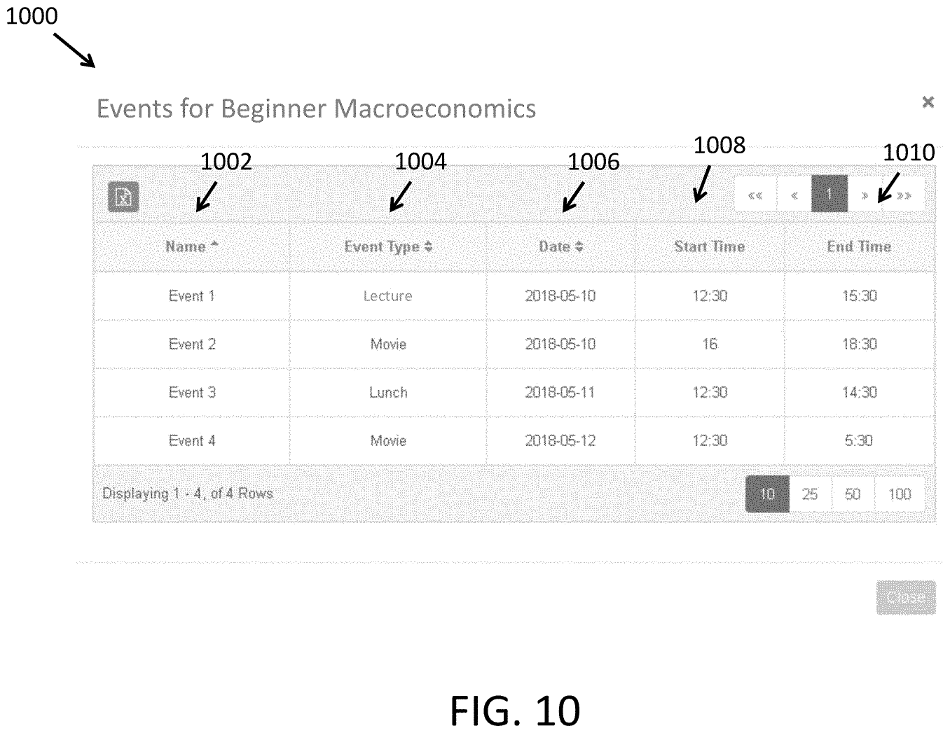

FIG. 10 depicts one embodiment of a user interface 1000. The user interface 1000 may include an event display user interface. The user interface 1000 may display one or more events that may be part of an educational offering. The user interface 1000 may include a name 1002. The name 1002 may include the name of the event. The user interface 1000 may include an event type 1004. The user interface 1000 may include a date of the event 1006. The user interface may include a start time 1008 or an end time 1010. In one embodiment, the event type 1004 may include a lecture, a movie, a meal, the administering of a test, lab work, study time, a group presentation, a roundtable discussion, a seminar, a symposium, a conference, or another type of event that may occur during the educational offering.

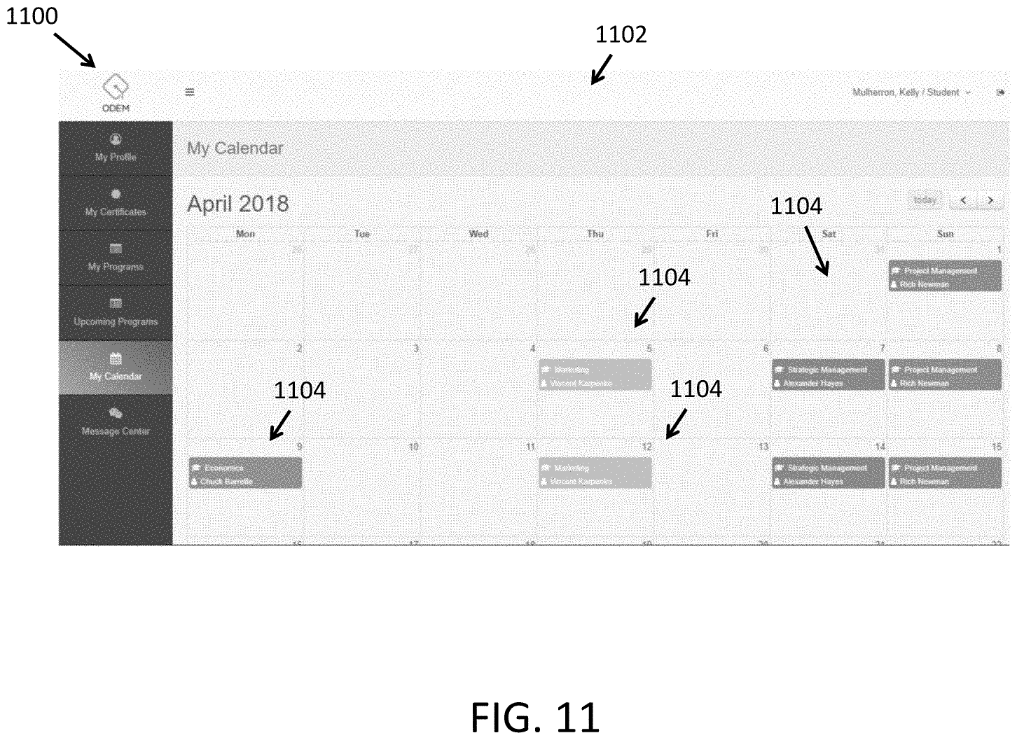

FIG. 11 depicts one embodiment of a user interface 1100. The user interface 1100 may include a calendar user interface. The user interface 1100 may display educational offering data pertaining to the user accessing the user interface 1100. The user interface 1100 may include a calendar 1102. The calendar 1102 may display days in a week, month, or other time interval. The user interface 1100 may include one or more events 1104. An event 1104 may correspond to an event that pertains to an educational offerings that the user is participating in. An event 1104 may correspond to other data in the system 100 such as sever maintenance (which may result in portions of the system 100 being temporarily unavailable to users).

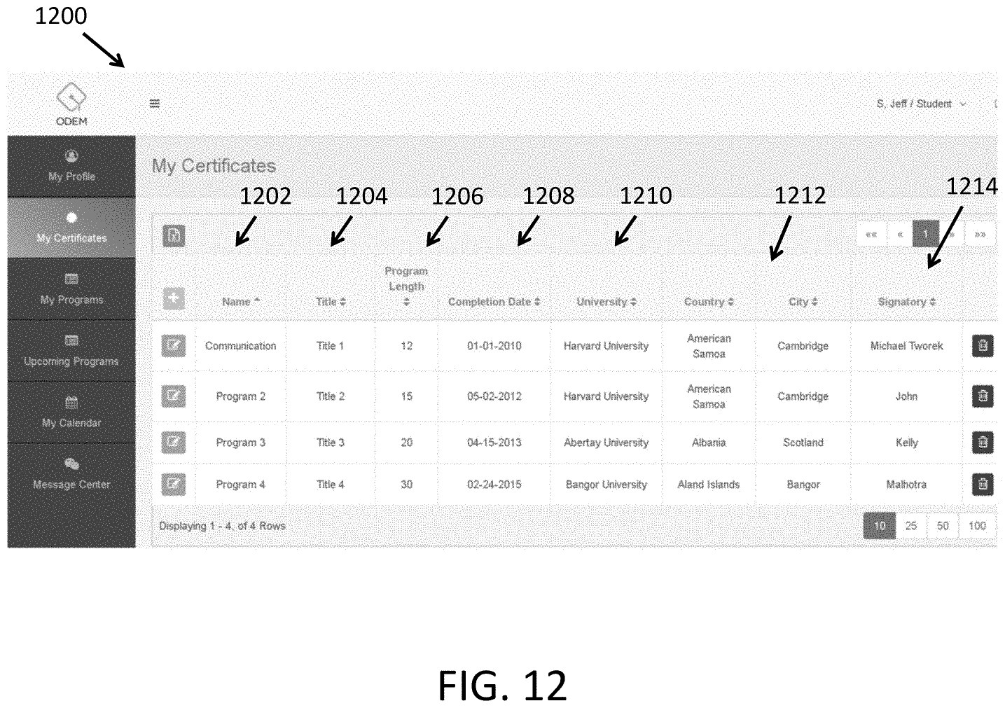

FIG. 12 depicts one embodiment of a user interface 1200. The user interface 1200 may include a certification display user interface. The user interface 1200 may display one or more educational certificates that belong to the user accessing the user interface 1200. An educational certificate displayed on the user interface 1200 may include an educational certificate issued by the education platform 108, issued by another institution and placed on the blockchain 102, or an educational certificate validated by the established entities 124.

The user interface 1200 may include a name 1202. The name 1202 may include the name of the educational offering corresponding to the educational certificate. The user interface 1200 may include a title 1204. The user interface 1200 may include a program length 1206. The user interface 1200 may include a completion date 1208. The user interface 1200 may include an institution 1210. The user interface 1200 may include a location 1212. The user interface 1200 may include a signatory 1214.

In one embodiment, the title 1204 of the educational certificate may include a string of text. The title 1204 may be customized by a user. The program length 1206 may include a length of the educational offering that corresponds to the educational certificate. The program length 1206 may be expressed in credit hours, classroom sessions, weeks, or some other time measurement. The completion date 1208 may include the date on which the educational offering was completed, the date on which the educational certificate was issued, or some other date. The institution 1210 may include the institution issuing the educational certificate. The institution 1210 may include the education platform 108, a college or university, or some other institution. The location 1212 may include data regarding the location where the educational offering took place, such as an institution, city, state, country, or other location data. In some embodiments, the signatory 1214 may include the educator user 116 that taught the educational offering, the institution issuing the educational certificate, one or more of the established entities 124, or another party.

In some embodiments, the system 100 may improve the functionality of a computer. For example, by leverage blockchain and smart contract technology, the execution of one or more functions described herein may be automatic upon receipt of a transaction 104 of the blockchain 102. For example, a smart contract 106 may automatically start an educational offering in response to detecting staking requirements being fulfilled by student users 114 and educator users 116. This is in contrast to conventional computer systems that may use a centralized database to track staking. Instead of an educator being paid by wire transfer, check, or direct deposit, which may take several days to prepare and process, the smart contract 106 may provide almost instantaneous payment to the educator or other service providers. Furthermore, by leveraging blockchain and smart contract technology, the system 100 provides immutable, decentralized proof of activities that occur in the system 100 such as students completing courses or earning educational certificates. This is in contract to a conventional computer system that may store data in a centralized database or file system, which can be modified, hacked, or lost.

Furthermore, the system 100 improves the functionality of a blockchain token system. In conventional blockchain token systems, users may convert fiat currency to tokens and then immediately spend the tokens. This may result in the users of the blockchain token network rarely possessing tokens. This may result in rapid price fluctuations or consistent low values of the token. In contract, the system 100, by having users stake tokens, which discourages immediate token usage, the users of the system 100 often possess tokens, which helps with price stability and may encourage long-term price appreciation of tokens. External market fluctuations that may not be related to the trust economy induced by the staking functions of the system 100 may have a reduced effect on student users 114 or educator users 116 utilizing the system 100.

In some embodiments, the system 100 may provide one or more benefits. For example, by leveraging smart contract 106 technology, the system 100 may automatically commit students, educators, and service provides to an educational offering. The use of a smart contract 106 and its functionality is not well-known, unconventional, and not routine in the education software arts and provides benefits over conventional education-hosting efforts.

In some embodiments, the system 100 may provide an online portal where users may easily request educational offerings. A user may be matched with the educational offering with the dates desired at lower overhead. In one embodiment, the system 100 may facilitate coordination between student users 114, educator users 116, service provider users 118, or other users, which may reduce middleman costs. Educator users 116 may propose and accept educational offerings with certain conditions, which may eliminate time spent negotiating.

In some embodiments, the smart contract 106 functionality of the system 100 may allow automatic execution of certain actions in the system 100. In some embodiments, a user's schedule is built automatically as part of a schedule request. This may remove uncertainty or last-minute requests to educational offering schedule and fulfillment. Terms and conditions of a smart contract 106 may automatically create the schedule.

In one embodiment, the system 100 may leverage blockchain 102-based transaction mechanisms. The system 100 may use tokens as a currency of transactions to provide faster, more reliable transactions in the system 100. The system 100 may orchestrate multi-payer, multi-payee, currency-agnostic transactions that may fulfill one or more financial requirements of an educational offering. In some embodiments, a purchase that may involve settlement services may include a deposit from a client, a payment from a client, a deposit from a third-party student representative, a payment from third-party student representative, an educational offering payment to an educator user 116, a payment to a facility, a payment for educational offering materials (e.g., books), or a payment for a service provider user 118 (e.g., a translator, caterer, transportation provider, or other service provider).

In some embodiments, a sponsor user 122 may provide benefits to the system 100. For example, a sponsor user 122 may promote access to learning for disadvantaged users. These users may include talented individuals without financial resources or who have disabilities. Sponsoring these individuals may result in greater earnings or tax revenue.

Other benefits not listed here may also be provided by the systems and methods disclosed herein.

In some embodiments, the described features, structures, or characteristics of the disclosure may be combined in one or more suitable manners. In the description herein, numerous specific details are provided, such as examples of programming, software, user selections, hardware, hardware circuits, hardware chips, or the like, to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

These features and advantages of the embodiments will become more fully apparent from the following description and appended claims, or may be learned by the practice of embodiments as set forth hereinafter. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Thus, although there have been described particular embodiments of the present invention of a new and useful SYSTEM AND METHOD FOR EDUCATIONAL OFFERING STAKING AND TOKEN ARCHITECTURE, it is not intended that such references be construed as limitations upon the scope of this invention.

What is claimed is:

1. A computer-implemented method, comprising:
using a cryptographic distributed ledger including a blockchain, wherein the cryptographic distributed ledger is capable of
hosting a first smart contract on the blockchain, the first smart contract including
a reference to an educational offering,
a first condition regarding one or more student users staking tokens, and
a second condition regarding one or more educator users staking tokens,
receiving indication that a student user has staked the educational offering by pledging a first amount of tokens;
receiving indication that an educator user has staked the educational offering by pledging a second amount of tokens;
determining that the first and second conditions of the smart contract are satisfied;
locking the first amount of tokens of the student user and the second amount of tokens of the educator user; and
in response to receiving indication of completion of the educational offering, issuing an educational certificate corresponding to the student user on the blockchain.

2. The computer-implemented method of claim 1, wherein the cryptographic distributed ledger is further capable of:
receiving indication of reneging by the student user; and
in response to the first amount of tokens of the student user not being locked, returning the first amount of tokens of the student user.

3. The computer-implemented method of claim 1, wherein the cryptographic distributed ledger is further capable of:
receiving, indication of reneging by the educator user; and
in response to the second amount of tokens of the educator user not being locked, returning the second amount of tokens of the educator user.

4. The computer-implemented method of claim 1, wherein the cryptographic distributed ledger is further capable of:
receiving indication of reneging by the student user on the educational offering; and
in response to the first amount of tokens of the student user being locked, returning at least a portion of the first amount of tokens of the student user to the educator user.

5. The computer-implemented method of claim 1, wherein the cryptographic distributed ledger is further capable of:
receiving indication of reneging by the educator user on the educational offering; and
in response to the second amount of tokens of the educator user being locked, returning at least a portion of the second amount of tokens of the educator user to the educator user.

6. The computer-implemented method of claim 1, wherein the cryptographic distributed ledger is further capable of, in response to receiving indication of completion of the educational offering:
unlocking at least a portion of the first amount of tokens of student user;
unlocking at least a portion of the second amount of tokens of the educator user; and
issuing payment to the educator user by transferring a third amount of tokens to the educator user via the blockchain.

7. The computer-implemented method of claim 1, wherein the cryptographic distributed ledger is further capable of, in response to receiving indication of completion of the educational offering:
rewarding the student user for completing the educational offering; and
rewarding the educator user for teaching the educational offering.

8. The computer-implemented method of claim 1, wherein the cryptographic distributed ledger is further capable of storing educational offering data.

9. The computer-implemented method of claim 8, wherein storing the educational offering data includes storing the educational offering data on at least one of:
a data storage of an education platform; or
the blockchain.

10. The computer-implemented method of claim 1, wherein the educational certificate comprises an immutable, non-transferable educational certificate.

11. The computer-implemented method of claim 1, wherein the cryptographic distributed ledger is further capable of:
receiving, from the educator user, an educator-generated educational offering;
licensing the educator-generated educational offering; and
generating a second smart contract on the blockchain, the second smart contract being configured to send royalty payments to the educator user for use of the educator-generated educational offering.

12. The computer-implemented method of claim 1, wherein the cryptographic distributed ledger is further capable of:
receiving, from a viewing user, a fourth amount of tokens;
displaying the educational certificate to the viewing user; and
distributing a portion of the fourth amount of tokens to the student user.

13. A computer-implemented method, comprising:
receiving an external educational activity;
receiving an indication of a student user staking a first amount of tokens;
sending, to one or more established entities, a request to validate the external educational activity;
receiving, from the one or more established entities, validation of the external educational activity; and
in response to receiving the validation,
issuing, on a blockchain, an educational certificate corresponding to the external educational activity, and
unlocking a portion of the first amount of tokens staked by the student user.

14. The computer-implemented method of claim 13, further comprising:
receiving, at the one or more established entities, the request to validate the external educational activity;
staking, by the one or more established entities, a second amount of tokens;
agreeing, by a predetermined portion of the one or more established entities, that the external educational activity is valid;
sending, from the one or more established entities, the validation of the external educational activity; and
unlocking the second amount of tokens staked by the one or more established entities.

15. The computer-implemented method of claim 13, further comprising:
receiving, at the one or more established entities, the request to validate the external educational activity;
staking, by the one or more established entities, a second amount of tokens;
agreeing, by a predetermined portion of the one or more established entities, that the external educational activity is not valid;
sending, from the one or more established entities, a rejection of the external educational activity; and
unlocking the second amount of tokens staked by the one or more established entities.

16. The computer-implemented method of claim 13, wherein receiving the educational activity comprises receiving a degree corresponding to the student user from an institution.

17. The computer-implemented method of claim 13, wherein an established entity of the one or more established entities comprises an educational institution.

18. A non-transitory computer-readable storage medium, comprising:
a processor; and
a set of instructions executable by the processor, wherein the processor executing the set of instructions causes the processor to implement a method comprising using a cryptographic distributed ledger configured to
define a set of prerequisite parameters,
generate, based on the set of prerequisite parameters, a contract between at least two parties,
store, on a decentralized ledger, the contract between the at least two parties,
distribute the set of prerequisite parameters to the at least two parties,
facilitate commitments between the at least two parties based on the set of prerequisite parameters,
coordinate the at least two parties to carry out educational activities based on the set of prerequisite parameters,
store educational activities related to the set of prerequisite parameters,
verify payment for the educational activities between the at least two parties,
record exchanges between the at least two parties,
allow the at least two parties to stake consideration on the verification of exchanges between said at least two parties, and
reward verified exchanges between said at least two parties with additional payments.
